(19) United States
(12) Patent Application Publication
(10) Pub. No.: US 2015/0332013 A1
(43) Pub. Date: Nov. 19, 2015

(54) HUMAN JOINT KINEMATICS INFORMATION EXTRACTION METHOD FROM MULTI-CHANNEL SURFACE ELECTROMYOGRAM SIGNALS, RECORDING MEDIUM AND DEVICE FOR PERFORMING THE METHOD

(71) Applicant: KOREA INSTITUTE OF SCIENCE AND TECHNOLOGY, Seoul (KR)

(72) Inventors: Jong Min LEE, Gunpo-si (KR); Seung-Jong KIM, Seoul (KR); Yoha HWANG, Seoul (KR); Kyoung Jae KIM, Seoul (KR); Sang hun CHUNG, Seoul (KR)

(73) Assignee: KOREA INSTITUTE OF SCIENCE AND TECHNOLOGY, Seoul (KR)

(21) Appl. No.: 14/331,825

(22) Filed: Jul. 15, 2014

(30) Foreign Application Priority Data
May 15, 2014 (KR) 10-2014-0058380

(51) Int. Cl. G06F 19/00; G06F 17/10

(52) U.S. Cl. CPC G06F 19/3437; G06F 17/10

(57) ABSTRACT

A human joint kinematics information extraction method includes generating a joint kinematics parameter estimator of a multiple linear model based on electromyogram (EMG) signals and joint kinematics information in the event of joint movement, measuring EMG signals in real time, and estimating joint kinematics information by applying the EMG signals measured in real time to the joint kinematics parameter estimator. Accordingly, human joint kinematics information may be extracted safely and accurately using surface EMG signals extracted non-invasively.

### CROSS-REFERENCE TO RELATED APPLICATION

This application claims priority to Korean Patent Application No. 10-2014-0058380, filed on May 15, 2014, and all the benefits accruing therefrom under 35 U.S.C. §119, the contents of which in its entirety are herein incorporated by reference.

### BACKGROUND

1. Field

The present disclosure relates to a human joint kinematics information extraction method and a recording medium and a device for performing the same, and more particularly, to a human joint kinematics information extraction method using surface electromyogram (EMG) signals extracted non-invasively and a recording medium and a device for performing the same.

2. Description of the Related Art

With the increasing use of smart phones and the development of various communication technologies, importance of interactions between humans and computers and between humans and robots is growing. In such interaction, an interface related technology which recognizes and transmits human intentions is the most important, however difficult. Recognizing human intentions accurately is also particularly important to the technology, and in this context, researches using bio-signals such as electroencephalogram (EEG), echocardiogram (ECoG), electromyogram (EMG) and electrocardiogram (ECG) signals have been actively conducted.

Particularly, recently, studies are being conducted on extracting joint kinematics information through bio-signals and using it as a human joint movement intention. Among them, typically, researches have been conducted on extracting lower limb kinematics information through brain signals (N. A. Fitzsimmons, et al. and A. Presacco, et al.).

N. A. Fitzsimmons, et al. involves building a multiple linear model using lower-limb kinematics information calculated through neural spikes extracted invasively and motion capture signals during monkey treadmill walking, calculating a weight matrix using a Wiener filter, and estimating gait kinematics information only from the neural spikes using the constructed weight matrix.

A. Presacco, et al. involves building a generalized linear model using lower-limb kinematics information calculated through EEG signals extracted non-invasively and motion capture signals during human treadmill walking, calculating a decoding matrix using a Wiener filter, and estimating lower-limb kinematics information only using the EEG signals through the constructed decoding matrix.

In the case of N. A. Fitzsimmons, et al. and A. Presacco, et al., it can be said that there is great significance in a method first proposed for each of invasive and non-invasive methods, however in the case of N. A. Fitzsimmons, et al., because it damages the brain, actually applying to humans is dangerous, and in the case of A. Presacco, et al., a drawback is that uniform performance is not always guaranteed due to time-variant characteristics of EEG signals. Particularly, in the case of A. Presacco, et al., delta waves of EEG signals were used to generate kinematics information, but a failure to establish a clinical basis for supporting that information directly related with the movement of lower limbs is included in delta waves is pointed out as a fault.

### SUMMARY

To address this issue, the present disclosure is directed to providing a human joint kinematics information extraction method using surface electromyogram (EMG) signals extracted non-invasively.

Also, the present disclosure is directed to providing a recording medium having a computer program recorded thereon for performing the human joint kinematics information extraction method.

Also, the present disclosure is directed to providing a device for performing the human joint kinematics information extraction method.

In one aspect, there is provided a human joint kinematics information extraction method according to an exemplary embodiment, including: generating a joint kinematics parameter estimator of a multiple linear model based on EMG signals and joint kinematics information in the event of joint movement; measuring EMG signals in real time; and estimating joint kinematics information by applying the EMG signals measured in real time to the joint kinematics parameter estimator.

In an exemplary embodiment of the present disclosure, the generating of the joint kinematics parameter estimator of the multiple linear model may include: simultaneously measuring EMG signals and joint kinematics information in the event of joint movement; building a multiple linear model in which the EMG signals are set as an input and joint kinematics information recorded in each locomotion mode is set as an output; and calculating weights of the multiple linear model.

In an exemplary embodiment of the present disclosure, the calculating of the weights of the multiple linear model may use one of a Wiener filter and a Kalman filter.

In an exemplary embodiment of the present disclosure, the generating of the joint kinematics parameter estimator of the multiple linear model may further include rectifying or filtering the EMG signals and the joint kinematics information.

In an exemplary embodiment of the present disclosure, the joint kinematics information may include at least one of a joint angle, a position, and an angular velocity.

In an exemplary embodiment of the present disclosure, the measuring of the EMG signals in real time may further include rectifying or filtering the EMG signals measured in real time.

In another aspect, there is provided a computer-readable recording medium according to an exemplary embodiment having a computer program recorded thereon for performing the human joint kinematics information extraction method.

In still another aspect, there is provided a device for performing human joint kinematics information extraction according to an exemplary embodiment, including: an off-line preprocessing unit to generate a joint kinematics parameter estimator of a multiple linear model based on EMG signals and joint kinematics information in the event of joint movement; and an on-line joint kinematics estimating unit to estimate joint kinematics information by applying EMG signals measured in real time to the joint kinematics parameter estimator.

In an exemplary embodiment of the present disclosure, the off-line preprocessing unit may include: a first measuring unit to simultaneously measure EMG signals and joint kinematics information in the event of joint movement; a model unit to build a multiple linear model in which the EMG signals are set as an input and joint kinematics information recorded in each locomotion mode is set as an output; and a weight calculating unit to calculate weights of the multiple linear model.

In an exemplary embodiment of the present disclosure, the joint kinematics information may be measured using a motion capture sensor while a joint is moving.

In an exemplary embodiment of the present disclosure, the EMG signals may be measured using an EMG sensor attached to a muscle related to the movement of the joint.

In an exemplary embodiment of the present disclosure, the weight calculating unit may calculate the weights using one of a Wiener filter and a Kalman filter.

In an exemplary embodiment of the present disclosure, the off-line preprocessing unit may include: a first signal processing unit to rectify and filter the EMG signals; and a second signal processing unit to filter the joint kinematics information.

In an exemplary embodiment of the present disclosure, the joint kinematics information may include at least one of a joint angle, a position, and an angular velocity.

In an exemplary embodiment of the present disclosure, the on-line joint kinematics estimating unit may include: a second measuring unit to measure EMG signals in real time; and an estimating unit to estimate joint kinematics information by applying the EMG signals measured in real time to the joint kinematics parameter estimator.

In an exemplary embodiment of the present disclosure, the on-line joint kinematics estimating unit may further include a third signal processing unit to rectify or filter the EMG signals measured in real time.

According to the human joint kinematics information extraction method, to extract human joint kinematics information from surface EMG signals extracted non-invasively, a multiple linear model is built in which envelope signals of an EMG are set as an input and joint kinematics information recorded in various locomotion modes is set as an output. When envelope signals rather than original EMG signals are used, there is an advantage that the technology disclosed herein always guarantees uniform performance by resolving time-variant characteristics of EMG signals. Also, as a method for calculating weights of the built model, a decoding matrix composed of model parameters is extracted using an estimation technique such as a Wiener filter. Subsequently, human joint kinematics information may be generated safely and accurately only using the EMG signals measured in real time and arithmetic calculation of the decoding matrix.

### BRIEF DESCRIPTION OF THE DRAWINGS

FIG. 1 is a block diagram illustrating a human joint kinematics information extraction device according to an exemplary embodiment.

FIG. 2 is a detailed block diagram illustrating the human joint kinematics information extraction device of FIG. 1.

FIG. 3 is filtered and rectified signals illustrating an envelope detection process of an electromyogram (EMG) signal.

FIG. 4 is a flowchart illustrating a human joint kinematics information extraction method according to an exemplary embodiment.

FIG. 5 is a detailed flowchart illustrating an off-line preprocessing process of FIG. 4.

FIGS. 6 and 7 are estimated joint angles (e.g., hip joint and knee joint) illustrating an example of joint kinematics information extracted according to the present disclosure.

### DETAILED DESCRIPTION

The following detailed description of the present disclosure is provided with reference to the accompanying drawings, in which particular embodiments by which the present disclosure may be practiced are shown for illustration. Rather, these exemplary embodiments are provided in full detail enough for those skilled in the art to practice the present disclosure. It should be understood that various embodiments of the present disclosure are different but do not need to be mutually exclusive. For example, a particular shape, structure, and feature stated herein may be implemented as other exemplary embodiment while being related to an exemplary embodiment without departing from the spirit and scope of the present disclosure. Also, it should be understood that changes may be made on a location or placement of an individual component in each embodiment disclosed herein without departing from the spirit and scope of the present disclosure. Therefore, the following detailed description is not taken in the limitative sense, and if properly described, is defined only by the appended claims along with the subject matter set forth in the claims and equivalents thereto. In the drawings, like reference numerals indicate identical or similar functions throughout many aspects.

Hereinafter, exemplary embodiments will be described in further detail with reference to the accompanying drawings.

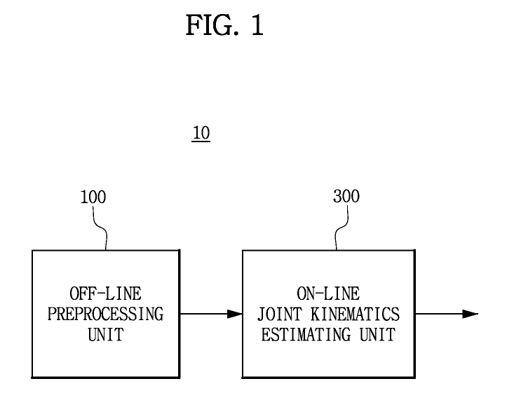

FIG. 1 is a block diagram illustrating a human joint kinematics information extraction device according to an exemplary embodiment of the present disclosure.

In the present disclosure, human joint kinematics information is extracted using surface electromyogram (EMG) signals extracted non-invasively. An EMG signal is an electrical signal produced by neuromuscular activity during muscular contraction, and an EMG signal lagging minutely behind an electroencephalogram (EEG) signal is observed, but actually an EMG signal occurs before a motion, and an EMG signal has superior time-invariant characteristics over an EEG signal and is a signal directly related to the movement of joints.

In the present disclosure, to extract human joint kinematics information from the non-invasively extracted surface EMG signals, a multiple linear model is built in which envelope signals of an EMG are set as an input, and joint kinematics information recorded in various locomotion modes is set as an output. Also, as a method for calculating weights of the built multiple linear model, a decoding matrix composed of model parameters is extracted using an estimation technique such as a Wiener filter or the like. Subsequently, human joint kinematics information may be generated only using the EMG signals measured in real time and arithmetic calculation of the decoding matrix.

To do so, referring to FIG. 1, the human joint kinematics information extraction device 10 (hereinafter referred to as a device) according to the present disclosure includes an off-line preprocessing unit 100 and an on-line joint kinematics estimating unit 300.

The device 10 of the present disclosure may execute software (application) for performing human joint kinematics information extraction which is installed therein, and the construction of the off-line preprocessing unit 100 may be controlled by the software for performing human joint kinematics information extraction running on the device 10.

The device 10 may be a separate terminal or a certain module of the terminal. The device 10 may have mobility or may be fixed. The device 10 may be in a form of a server or an engine, and may be also called a device, an apparatus, a terminal, a user equipment (UE), a mobile station (MS), a mobile terminal (MT), a user terminal (UT), a subscriber station (SS), a wireless device, a personal digital assistant (PDA), a wireless modem, a handheld device, and the like.

The off-line preprocessing unit 100 generates a joint kinematics parameter estimator of a decoding matrix or a multiple linear model based on EMG signals and joint kinematics information in the event of joint movement.

When the joint kinematics parameter estimator is generated through an off-line preprocessing process, as a subsequent on-line processing process, the on-line joint kinematics estimating unit 300 may continuously extract joint kinematics information only using the joint kinematics parameter estimator generated during the off-line preprocessing process and the measured EMG signals without a separate additional operation.

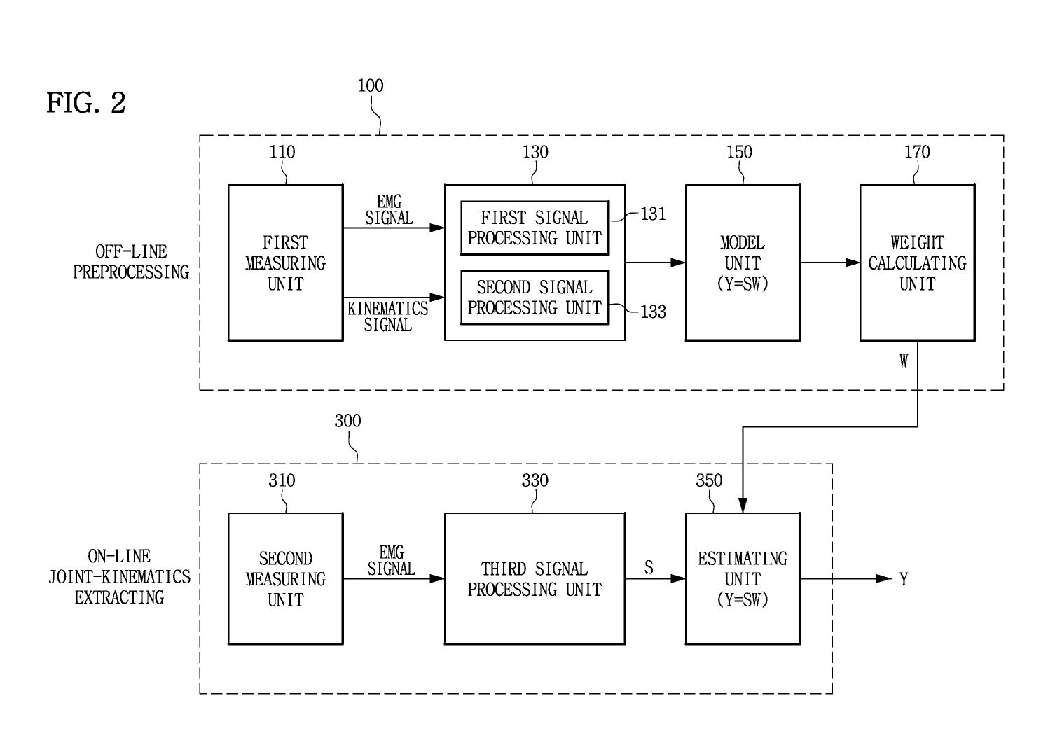

Specifically, referring to FIG. 2, the off-line preprocessing unit 100 may include a first measuring unit 110, a model unit 150, and a weight calculating unit 170. Also, the off-line preprocessing unit 100 may further include a signal processing unit 130.

The first measuring unit 110 simultaneously measures EMG signals and joint kinematics information in the event of joint movement. For example, the first measuring unit 110 may extract kinematics information of a joint to be extracted using a motion capture sensor while the corresponding joint is moving, and at the same time, may measure EMG signals from an EMG sensor attached to a muscle related to the movement of the corresponding joint. The joint kinematics information may include at least one of a joint angle, a position, and an angular velocity.

The signal processing unit 130 rectifies or filters the measured EMG signals and the joint kinematics information for noise removal. As an embodiment, the signal processing unit 130 may include a first signal processing unit 131 to additionally perform full-wave rectification and low-pass filtering processes for envelope detection of the EMG signals, and a second signal processing unit 133 to perform low-pass filtering of the joint kinematics information.

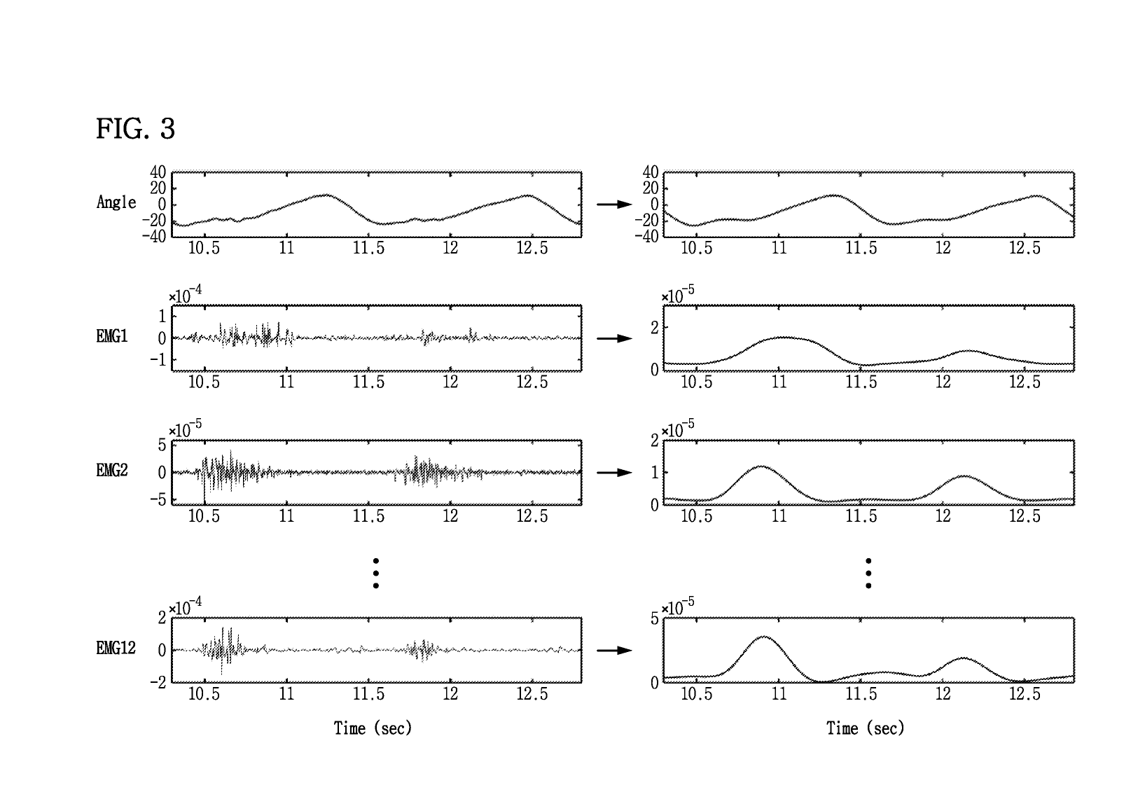

FIG. 3 illustrates the measured original EMG signals and the envelope of each EMG signal corresponding thereto.

The model unit 150 builds a multiple linear model in which the EMG signals are set as an input and joint kinematics information recorded in each locomotion mode is set as an output. Describing this in a mathematical expression, Equation 1 is given as follows:

$$y ( t ) = a + {\sum }_{n = 1}^{N} {\sum }_{k = 1}^{L} {b}_{nk} {S}_{n} ( t - k ) + ɛ ( t ) \qquad [ Equation 1 ]$$

In Equation 1, y(t) denotes lower-limb kinematics information. Specifically, y(t) is a time series signal of x, y, z, θ, dθ/dt, and represents a position, an angle, and an angular velocity of a human joint (a hip joint, a knee joint, an ankle joint, a carpal joint, an elbow joint, a shoulder joint, and the like). L and N denote a number of samples of EMG signals (time delay) and a number of sensors, respectively, and sₙ(t−k) is a muscle envelope signal measured from a sensor n at a delay time k. ε(t) denotes a residual, and a and b denote weights of a multiple linear model.

Finally, when the weights a and b of the multiple linear model are calculated in the off-line preprocessing process, joint kinematics information may be estimated only using the EMG signals sₙ(t−k) in the subsequent on-line real-time joint kinematics extraction process.

The weight calculating unit 170 performs a process for extracting model parameters of the multiple linear model. As a method for calculating the weights a and b of the multiple linear model, a Wiener filter may be used. The Wiener filter refers to a filter which converts an input to a result very close to a desired output as possible, and here, the expression “very close as possible” represents that a sum of squares of a difference between a filter output and a desired result is a minimum, and may be also known as a least squares filter. To describe this in a mathematical expression, when Equation 1 is converted into a matrix form, Equation 2 is given as follows:

Y−sw+ε [Equation 2]

In Equation 2, w denotes a model weight matrix composed of a and b, and a method for calculating this is represented by Equation 3:

W=(S^{T}S)⁻¹S^{T}Y [Equation 3]

The Wiener filter may be continuously used as a decoder for a new EMG signal after being trained. Although a Wiener filter was used in this embodiment, as an estimation method for calculating a weight matrix, a Kalman filter-based estimation algorithm (Kalman filter, unscented Kalman filter) may be used, and it is obvious that other conventional estimation methods may be applied according to necessity.

When the joint kinematics parameter estimator is generated through the off-line preprocessing process, the on-line joint kinematics estimating unit 300 may continuously extract joint kinematics information by an on-line processing process.

Specifically, referring to FIG. 2, the on-line joint kinematics estimating unit 300 includes a second measuring unit 310 to measure EMG signals in real time, and an estimating unit 350 to estimate joint kinematics information by applying the EMG signals measured in real time to the joint kinematics parameter estimator.

The on-line joint kinematics estimating unit 300 may further include a third signal processing unit 330 to rectify or filter the measured EMG signals for noise removal. For example, the third signal processing unit 330 may additionally perform a process for full-wave rectification and low-pass filtering of the EMG signals.

The present disclosure proposes a method for generating human joint kinematics information (a joint angle, a position, and an angular velocity) using surface EMG signals. Specifically, the present disclosure presents a technique that may estimate joint kinematics information only using multi-channel surface EMG signals through a multiple linear model and a model parameter estimation technique based on a Wiener filter. Accordingly, the estimated joint kinematics information may be used as joint movement intention information in various applications of exercise rehabilitation robots and assistant robots for activities in daily living.

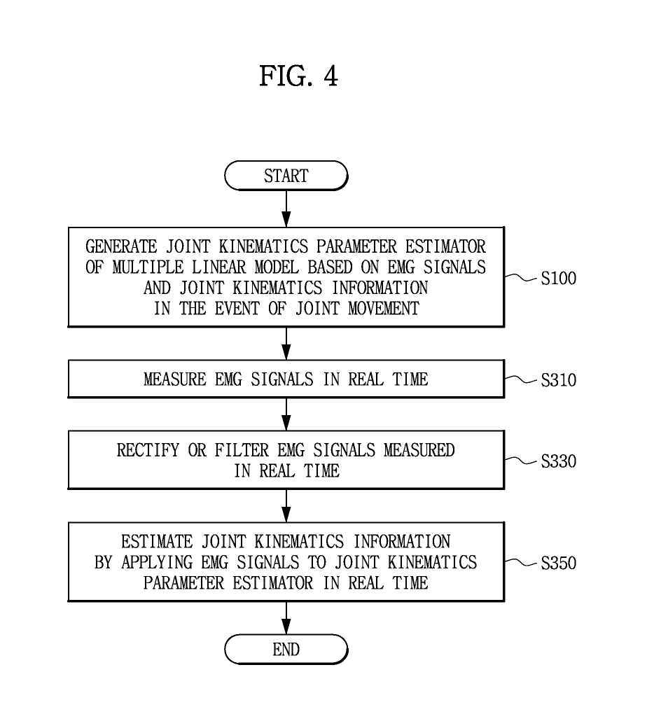

FIG. 4 is a flowchart illustrating a human joint kinematics information extraction method according to an exemplary embodiment.

The human joint kinematics information extraction method according to this embodiment may be run in a substantially same configuration as the device 10 of FIG. 1. Accordingly, the same components as the device 10 of FIG. 1 are given the same reference numerals, and a repeated description is omitted herein.

Alternatively, the human joint kinematics information extraction method according to this embodiment may be performed by software (application) for human joint kinematics information extraction.

Referring to FIG. 4, the human joint kinematics information extraction method according to this embodiment generates a joint kinematics parameter estimator of a multiple linear model based on EMG signals and joint kinematics information in the event of joint movement (S100).

The operation of generating the joint kinematics parameter estimator of the multiple linear model (S100) corresponds to an off-line preprocessing process before estimating joint kinematics information, and is a process of generating a joint kinematics parameter estimator of a decoding matrix or a multiple linear model based on EMG signals and joint kinematics information in the event of joint movement.

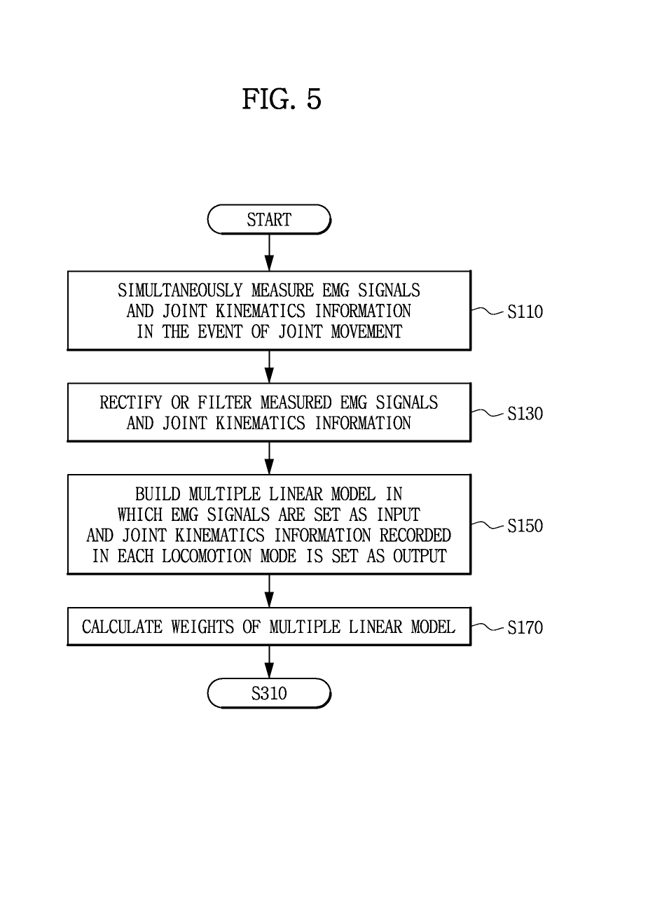

Referring to FIG. 5, specifically describing the operation of generating the joint kinematics parameter estimator of the multiple linear model (S100), first, EMG signals and joint kinematics information in the event of joint movement are measured simultaneously (S110).

For example, kinematics information of a joint to be extracted may be extracted using a motion capture sensor while the corresponding joint is moving, and at the same time, EMG signals may be measured from an EMG sensor attached to a muscle related to the movement of the corresponding joint. The joint kinematics information may include at least one of a joint angle, a position, and an angular velocity.

Subsequently, for noise removal, an operation of rectifying or filtering the measured EMG signals and the joint kinematics information may be further included (S130). As an embodiment, full-wave rectification and low-pass filtering processes of the EMG signals may be additionally performed for envelope detection as shown in FIG. 3. Also, the joint kinematics information may be low-pass filtered.

Subsequently, a multiple linear model is built in which the EMG signals are set as an input and joint kinematics information recorded in each locomotion mode is set as an output (S150). Describing this in a mathematical expression, the above Equations 1 through 3 are given.

When the multiple linear model is built, an operation for extracting model parameters of the multiple linear model is performed (S170). In this instance, as a method of calculating weights a and b of the multiple linear model, a Wiener filter or a Kalman filter may be used.

When the joint kinematics parameter estimator is generated through the off-line preprocessing process, as a subsequent on-line processing process, joint kinematics information may be continuously extracted.

Specifically, EMG signals are measured in real time (S310), and joint kinematics information is estimated by applying the measured EMG signals to the joint kinematics parameter estimator generated in the off-line preprocessing process (S350). In this instance, for noise removal, an operation of rectifying or filtering the measured EMG signals may be further included (S330).

Recently, there was a research report that gait rehabilitation of stroke patients is closely related to recovery of brain function. Afterwards a theory that rehabilitation therapy designed to move in accordance with a gait intention detected from brain and neural signals of a stroke patient contributes to enhancement of brain function was announced, and to demonstrate this, research get started with a gait rehabilitation robot. The gait intention may present criteria for a motion time, a motion pattern, and a motion mode, and joint kinematics information may be an important means for determining motion time and pattern information among them. To acquire joint kinematics information, a conventional motion capture method may be used, but this is just a result of walking and is not considered as a gait intention.

Accordingly, if joint kinematics information can be acquired through EMG signals as in the present disclosure, a robot system for rehabilitation training based on the theory brought up in recent days may be constructed. Hereinafter, accuracy and effects of the EMG signals estimated according to the present disclosure is proved.

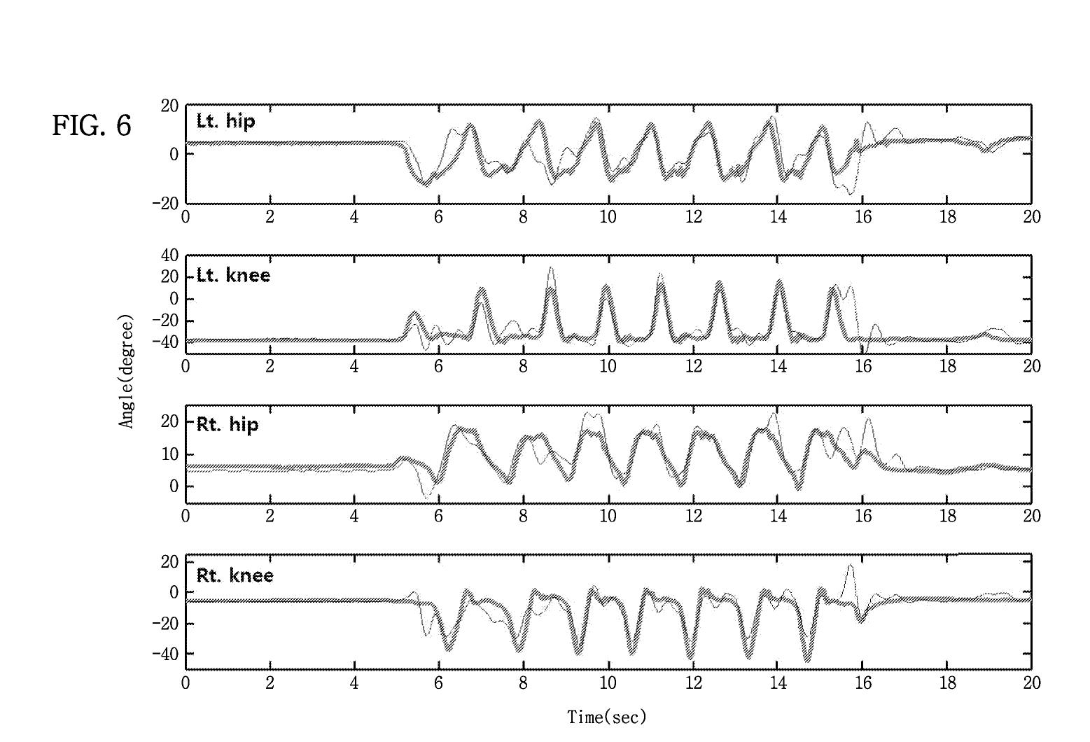

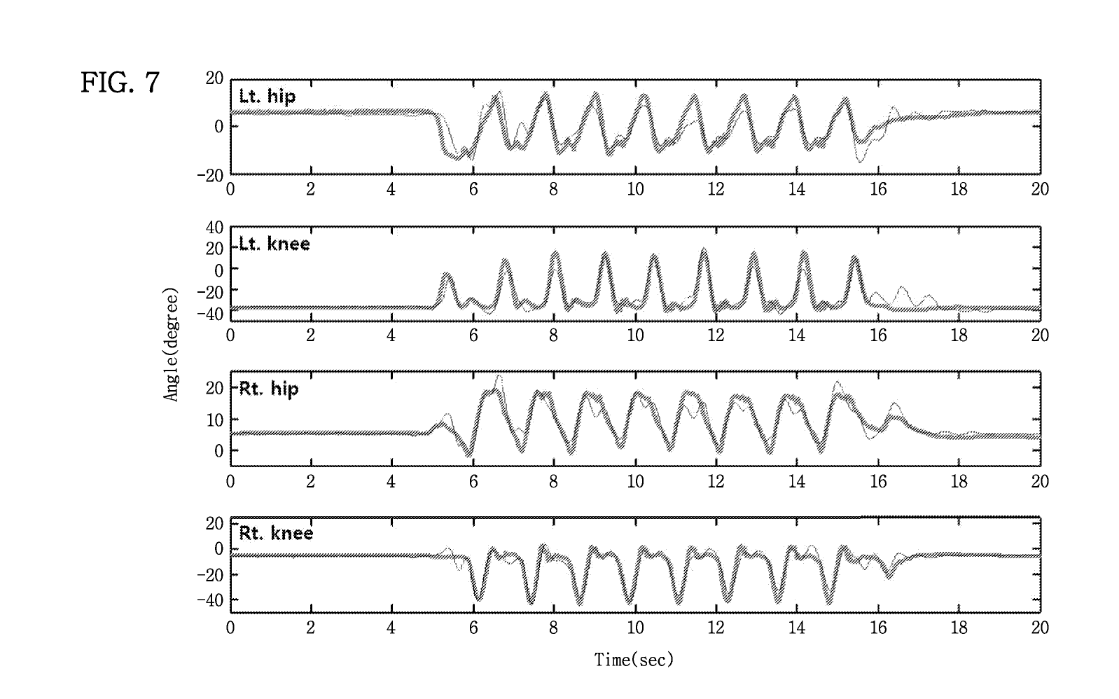

FIGS. 6 and 7 are estimated joint angles (e.g., hip joint and knee joint) illustrating an example of joint kinematics information extracted according to the present disclosure.

To demonstrate the performance of the present disclosure, examples in which the method proposed by the present disclosure is applied to a surface EMG when a non-disabled person walks on the flat land were each appended to FIGS. 6 and 7. In FIGS. 6 and 7, a unit of an x-axis is a second and a unit of a y-axis is an angle.

During walking at a natural speed, EMG signals were measured at 12 portions of a lower limb of a subject (gluteus medius, rectus femoris, vastus medialis, hamstring, tibialis anterior, and gastrocnemius of the left and right legs) at a sampling rate of 2,000 Hz. As kinematics information of each joint of the lower limb for building a multiple linear model, angle values of hip joints and knee joints of the left and right legs measured through an angle measuring instrument were used. If a motion capture sensor is used, absolute coordinates, an angle, and an angular velocity of each joint part may be also measured.

With the measured joint angles and EMG signals, a decoding matrix or a joint kinematics parameter estimator was generated, and using the generated estimator and the EMG signals, joint angles were extracted. As a result, a graph illustrating a comparison of the measured joint angles and the extracted joint angles is as shown in FIGS. 6 and 7.

FIGS. 6 and 7 each shows a left hip joint angle, a left knee joint angle, a right hip joint angle, and a right knee joint angle, and a thick grey line represents the measured joint angles and a thin line represents the extracted joint angles. Because the thick grey line and the thin line exhibit very similar results, it can be seen that joint kinematics information was extracted very closely to actual measurements. Accordingly, it was demonstrated that joint kinematics information could be extracted only using EMG signals by the method proposed in the present disclosure.

As such, the human joint kinematics information extraction method on the multi-channel surface EMG may be embodied as an application or a computer instruction executable through various computer components recorded in computer-readable recording media. The computer-readable recording media may include a computer instruction, a data file, a data structure, and the like, singularly or in combination.

The computer instruction recorded in the computer-readable recording media may be not only a computer instruction designed or configured specially for the present disclosure, but also a computer instruction available and known to those skilled in the field of computer software.

The computer-readable recording media includes hardware devices specially configured to store and execute a computer instruction, for example, magnetic media such as hard disks, floppy disks, and magnetic tape, optical media such as CD ROM disks and digital video disc (DVD), magneto-optical media such as floptical disks, read-only memory (ROM), random access memory (RAM), flash memories, and the like.

The computer instruction may include, for example, a high level language code executable by a computer using an interpreter or the like, as well as machine language code created by a compiler or the like. The hardware device may be configured to operate as at least one software module to perform processing according to the present disclosure, or vice versa.

While the present disclosure has been described hereinabove with reference to the exemplary embodiments, it will be apparent to those skilled in the art that various modifications and changes may be made without departing from the spirit and scope of the present disclosure set forth in the appended claims.

The present disclosure provides a method for discerning a movement intention using a human EMG with more convenience and long-term safety. Recently, exercise rehabilitation robotics is shifting its paradigm from a bottom-up approach involving simply repeated rehabilitation exercise therapy irrespective of a movement intention to a top-down rehabilitation approach reflecting patients' intentions, and for this purpose, neural-machine interface technology is combined therewith. By applying a movement intention based on brain/neural signals (EEG, EMG, and the like) to rehabilitation training, brain plasticity of post-stroke hemiplegic patients may be promoted, contributing to exercise rehabilitation of upper and lower limbs.

The present disclosure may implement an EMG-based movement intention detection technique in the applications of rehabilitation robots for upper and lower limbs capable of reflecting a movement intention, and through this, may apply rehabilitation therapy converted into a top-down approach to stroke patients. Also, the present disclosure may implement an EMG-based movement intention detection technique in the applications of upper and lower limb-assistive robots and prosthetic arms and legs, and through this, may help users to move assistant robots and prosthetic arms and legs in accordance with their intentions. Accordingly, it is expected that the present disclosure will be widely applied in the rehabilitation-related biointerface field.

What is claimed is:

1. A human joint kinematics information extraction method, comprising:
generating a joint kinematics parameter estimator of a multiple linear model based on electromyogram (EMG) signals and joint kinematics information in the event of joint movement;
measuring EMG signals in real time; and
estimating joint kinematics information by applying the EMG signals measured in real time to the joint kinematics parameter estimator.

2. The human joint kinematics information extraction method according to claim 1, wherein the generating of the joint kinematics parameter estimator of the multiple linear model comprises:
simultaneously measuring EMG signals and joint kinematics information in the event of joint movement;
building a multiple linear model in which the EMG signals are set as an input and joint kinematics information recorded in each locomotion mode is set as an output; and
calculating weights of the multiple linear model.

3. The human joint kinematics information extraction method according to claim 2, wherein the calculating of the weights of the multiple linear model uses one of a Wiener filter and a Kalman filter.

4. The human joint kinematics information extraction method according to claim 2, wherein the generating of the joint kinematics parameter estimator of the multiple linear model further comprises rectifying or filtering the EMG signals and the joint kinematics information.

5. The human joint kinematics information extraction method according to claim 1, wherein the joint kinematics information includes at least one of a joint angle, a position, and an angular velocity.

6. The human joint kinematics information extraction method according to claim 1, wherein the measuring of the EMG signals in real time further comprises rectifying or filtering the EMG signals measured in real time.

7. A computer-readable recording medium having a computer program recorded thereon for performing the human joint kinematics information extraction method according to claim 1.

8. A human joint kinematics information extraction device, comprising:
an off-line preprocessing unit to generate a joint kinematics parameter estimator of a multiple linear model based on electromyogram (EMG) signals and joint kinematics information in the event of joint movement; and
an on-line joint kinematics estimating unit to estimate joint kinematics information by applying EMG signals measured in real time to the joint kinematics parameter estimator.

9. The human joint kinematics information extraction device according to claim 8, wherein the off-line preprocessing unit comprises:
a first measuring unit to simultaneously measure EMG signals and joint kinematics information in the event of joint movement;
a model unit to build a multiple linear model in which the EMG signals are set as an input and joint kinematics information recorded in each locomotion mode is set as an output; and
a weight calculating unit to calculate weights of the multiple linear model.

10. The human joint kinematics information extraction device according to claim 9, wherein the joint kinematics information is measured using a motion capture sensor while a joint is moving.

11. The human joint kinematics information extraction device according to claim 10, wherein the EMG signals are measured using an EMG sensor attached to a muscle related to the movement of the joint.

12. The human joint kinematics information extraction device according to claim 9, wherein the weight calculating unit calculates the weights using one of a Wiener filter and a Kalman filter.

13. The human joint kinematics information extraction device according to claim 9, wherein the off-line preprocessing unit comprises:
a first signal processing unit to rectify and filter the EMG signals; and
a second signal processing unit to filter the joint kinematics information.

14. The human joint kinematics information extraction device according to claim 8, wherein the joint kinematics information includes at least one of a joint angle, a position, and an angular velocity.

15. The human joint kinematics information extraction device according to claim 8, wherein the on-line joint kinematics estimating unit comprises:
a second measuring unit to measure EMG signals in real time; and
an estimating unit to estimate joint kinematics information by applying the EMG signals measured in real time to the joint kinematics parameter estimator.

16. The human joint kinematics information extraction device according to claim 15, wherein the on-line joint kinematics estimating unit further comprises:
a third signal processing unit to rectify or filter the EMG signals measured in real time.
